(19) United States
(12) Patent Application Publication
(10) Pub. No.: US 2008/0174792 A1
(43) Pub. Date: Jul. 24, 2008

(54) IMAGE FORMING SYSTEM

(75) Inventor: Takayuki Nishi, Fujisawa-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/626,492

(22) Filed: Jan. 24, 2007

(51) Int. Cl. H04N 1/23

(52) U.S. Cl. 358/1.6

(57) ABSTRACT

An image forming system has an image forming apparatus that performs monochrome printing and a color printer connected to the image forming apparatus. This image forming apparatus includes a color scanner unit that scans an original, a color determining unit that determines whether a color original is included in originals scanned by the color scanner unit, an image-data storing unit that stores page data, a monochrome printing unit that converts the page data into an image and prints the image with a monochrome image quality, and an output-destination setting unit that sets, when the color determining unit determines that a color original is included in the originals, a printout destination of page data of the color original in the dolor printer and sets a printout destination of page data of a monochrome original in the monochrome printing unit.

### BACKGROUND OF THE INVENTION

1. Field of the Invention

The present invention relates to an image forming system that has a monochrome printing unit and a color printing unit and that can perform efficient printing and printing desired by a user.

2. Description of the Related Art

In a digital multifunction peripheral (MFP) that is an example of an image forming apparatus, recently, more and more models of the MFP cope with color printing. However, there are only a small number of models of a high-speed color MFP having output speed equal to or higher than Seg4 and the models are expansive. On the other hand, in a color MFP generally used, for example, when a job for treating an original with a large number of pages is executed, processing time for the job is long. This causes a situation in which execution of the next job is kept waiting.

The color MFP is also used as a printer for printing a document created by a personal computer. In JP-A-2002-103750, a printer system in which a color printer and a monochrome printer are connected to a host apparatus via a server apparatus is disclosed. In this system, the server apparatus receives print data from the host apparatus and outputs a monochrome page to the monochrome printer and outputs a color page to the color printer.

The monochrome printer determines whether the color printer is in a print standby state. When the color printer is in the print standby state, the monochrome printer transmits a part of the print data to the color printer. The color printer prints the print data received. It is possible to modify this system into a system in which the server apparatus allocates the print data to the color printer and the monochrome printer on the basis of printing states and performance of the color printer and the monochrome printer.

According to such a system, when a mixed original in which monochrome pages and color pages are mixed, in particular, a mixed original including a large number of monochrome pages is treated, a part of the monochrome pages is printed by the color printer. This makes it possible to perform efficient printing.

However, in such a system, when a user desires to print an original using one of the printers, the user cannot select the printer. For example, when the user desires to print the mixed original in a gray scale using the monochrome MFP, this system cannot cope with a request for the printing. When a mixed original including a large number of pages in which monochrome pages and color pages are complicatedly mixed is dividedly printed by the monochrome printer and the color printer, it takes time to rearrange obtained prints in an order of pages later. Thus, the system is not always efficient. Moreover, when an original is dividedly printed by the monochrome printer and the color printer regardless of the fact that the original is a monochrome original, labor and time for rearranging obtained prints in an order of pages are necessary.

### SUMMARY OF THE INVENTION

It is an object of the invention to provide an image forming system that can efficiently perform monochrome printing and color printing, can obtain a print result desired by a user, and can be constituted inexpensively.

An image forming system according to a first aspect of the invention has a structure in which a color printer that performs color printing is connected to an image forming apparatus that performs monochrome printing. This image forming apparatus includes a color scanner unit that scans an original. It is determined by a color determining unit whether a color original is included in originals scanned by this color scanner unit. Page data scanned by the color scanner unit is stored in an image-data storing unit. A printing unit included in the image forming apparatus is a monochrome printing unit that converts the page data into an image and prints the image with a monochrome image quality. When the color determining unit determines that a color original is included in the originals, a printout destination of page data of the color original is set in the color printer and a printout destination of page data of a monochrome original is set in the monochrome printing unit. The image forming apparatus has an output-destination setting unit that performs such setting.

An image forming system according to a second aspect of the invention also has a structure in which a color printer that performs color printing is connected to an image forming apparatus that performs monochrome printing. This image forming apparatus has a color scanner unit that scans an original. Page data scanned by the color scanner unit is stored in an image-data storing unit. A printing unit included in the image forming apparatus is a monochrome printing unit that converts the page data into an image and prints the image with a monochrome image quality. It is determined by an operation monitoring unit whether this monochrome printing unit is busy. When the operation monitoring unit determines that the monochrome printing unit is busy, a printout destination of the page data is set in the color printer. The image forming apparatus has an output-destination setting unit that performs such setting.

According to such an image forming system, it is possible to efficiently perform monochrome printing and color printing. It is also possible to obtain a print result desired by the user. It is possible to constitute the image forming apparatus inexpensively. Moreover, the image forming system has a wide variety of options of color printers and is excellent in scalability of the system.

### BRIEF DESCRIPTION OF THE DRAWINGS

FIG. 1 is a diagram showing a structure of an image forming system according to an embodiment of the invention; and

FIG. 2 is a flowchart of image formation processing in the image forming system.

### DETAILED DESCRIPTION OF PREFERRED EMBODIMENTS

Embodiments of the invention will be hereinafter explained in detail with reference to the drawings.

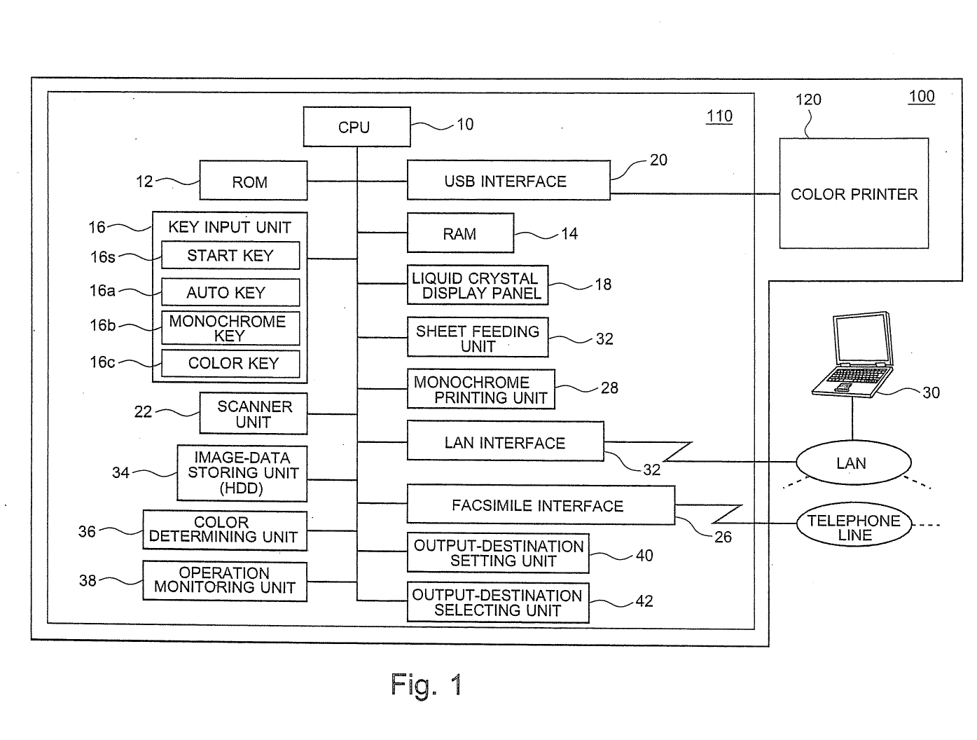

A structure of an image forming system according to an embodiment of the invention is shown in FIG. 1. This image forming system 100 includes a digital multifunction peripheral (MFP) 110 that has functions of a copier, a printer, a scanner, and a facsimile and a color printer 120.

The MFP 110 includes a central processing unit (CPU) 10 that manages operation control and data processing for the MFP 110, a ROM 12 having stored therein program data for the operation control and the data processing for the MFP 110, a RAM 14 for temporarily storing control information and the like at the time of an operation of the MFP 110, a key input unit 16 that has various buttons such as a start key 16s for operating the MFP 110, a liquid crystal display panel 18 for displaying operation information complying with operation of the key input unit 16 and information on a job in progress, and a USB interface 20 for performing data communication with the color printer 120. The liquid crystal display panel 18 has a touch panel function.

The MFP 110 also includes a scanner unit 22 for scanning an original, a facsimile interface 24 for performing transmission and reception of facsimile data through a telephone line, a LAN interface 26 for transmitting and receiving data between the MFP 110 and a personal computer (PC) 30 connected to each other via a LAN, a monochrome printing unit 28 that converts page data captured into the MFP 110 into an image and prints the image on a sheet, a sheet feeding unit 32 for feeding a sheet to the monochrome printing unit 28, and an image-data storing unit 34 for storing page data treated by the MFP 110.

The scanner unit 22 includes, in addition to an original stand, an ADF that automatically scans originals one by one. The scanner unit 22 includes a color CCD and can scan not only a monochrome original (an original formed by only white and black) but also a color original (an original including colors other than white and black). Bitmap data (image data) of an original scanned by the scanner unit 22 is converted into page data for each page of the original.

As the page data captured into the MFP 110, there are page data of the original scanned by the scanner unit 22, page data of print data transmitted from the PC 30, and page data of image data transmitted from the outside by facsimile communication.

The monochrome printing unit 28 can print a monochrome image (an image formed by only white and black) including a gray scale image on a sheet. However, the monochrome printing unit 28 cannot print a color image (an image including colors other than white and black) on a sheet.

As the image-data storing unit 34, a hard disk drive (HDD) is suitably used.

The MFP 110 further includes a color determining unit 36 that determines whether page data including a color image (hereinafter referred to as “color page data”) is included in page data treated by the MFP 110 and an operation monitoring unit 38 that determines whether the monochrome printing unit 28 is busy.

In other words, the color determining unit 36 determines whether a color original is included in copy originals and whether a color image is included in print data transmitted from the PC 30. The color determining unit 36 includes a storage device such as a ROM having stored therein a program for color determination, a CPU that executes the program, and a RAM for storing determination information.

The operation monitoring unit 38 includes a sensor that monitors an operation state of the monochrome printing unit 28, a ROM having stored therein a program for analyzing detection information of this sensor, a CPU that executes the program, and a RAM for storing monitoring information. The operation monitoring unit 38 determines whether the monochrome printing unit 28 is busy by monitoring a transmission state of page, data to the monochrome printing unit 28, a stock state of un-outputted page data stored in the image-data storing unit 34, and the like.

When the monochrome printing unit 28 is busy, this means a state in which a prior job is in progress to such a degree as to make it impossible to promptly execute a new copy job or a printout job from the PC 30.

The MFP 110 includes an output-destination setting unit 40 that automatically sets a printout destination in accordance with determination of the color determining unit 36 and determination of the operation monitoring unit 38. Modes for setting the printout destination by this output-destination setting unit 40 are roughly divided into the following two modes.

A first mode is a mode for setting the color printer 120 as a printout destination of color page data and setting the monochrome printing unit 28 as a printout destination of monochrome page data (page data not including a color image) (hereinafter referred to as “separation mode”).

A second mode is a mode for setting the color printer 120 as a printout destination when at least one piece of color page data is included and setting the monochrome printing unit 28 as a printout destination when color page data is not included (hereinafter referred to as “collective mode”).

It is possible to perform selection of the separation mode and the collective mode using the liquid crystal display panel 18. As described later, in a state in which an auto key 16a provided as one of the input keys 16 is depressed and selected, icons of the “separation mode” and the “collective mode” are displayed on the liquid crystal display panel 18. The user can select a desired mode. In a default setting, it is assumed that the separation mode is selected.

The output-destination setting unit 40 has a function of automatically setting a printout destination of the page data, which is stored in the image-data storing unit 34, in the color printer 120 when the operation monitoring unit 38 determines that the monochrome printing unit 28 is busy.

The MFP 110 also includes an output-destination selecting unit 42 for the user to preferentially designate one of the monochrome printing unit 28 and the color printer 120 as a printout destination. The output-destination selecting unit 42 limits the automatic setting function of the output-destination setting unit 40.

In other words, when the user designates the monochrome printing unit 28 as a printout destination of page data with the output-destination selecting unit 42 in advance, regardless of determination of the output-destination setting unit 40, printing is performed by the monochrome printing unit 28. When the user designates the color printer 120 as a printout destination of page data with the output-destination selecting unit 42 in advance, regardless of determination of the output-destination setting unit 40, printing is performed by the color printer 120.

The output-destination selecting unit 42 recognizes a printout destination selected by the user according to depression of a selection key provided in the key input unit 16. The auto key 16a for causing the output-destination setting unit 40 to automatically select a printout destination of page data, a monochrome key 16b for setting a printout destination in the monochrome printing unit 28, and a color key 16c for setting a printout destination in the color printer 120 are provided in the key input unit 16.

When the user depresses a desired key among these keys, information on the depression is transmitted to the output-destination selecting unit 42. The output-destination selecting unit 42 limits the automatic setting function of the output-destination setting unit 40. The key selected by the user is displayed, for example, by illumination. Consequently, the user can easily recognize which key is selected.

The output-destination selecting unit 42 may be provided in the liquid crystal display panel 18. The user can designate a printout destination of page data using the touch panel function of the liquid crystal display panel 18.

A laser printer or an ink jet printer is suitable used as the color printer 120. Here, a form in which USB connection is used for bilateral communication connection between the MFP 110 and the color printer 120 is shown. However, LAN connection may be used.

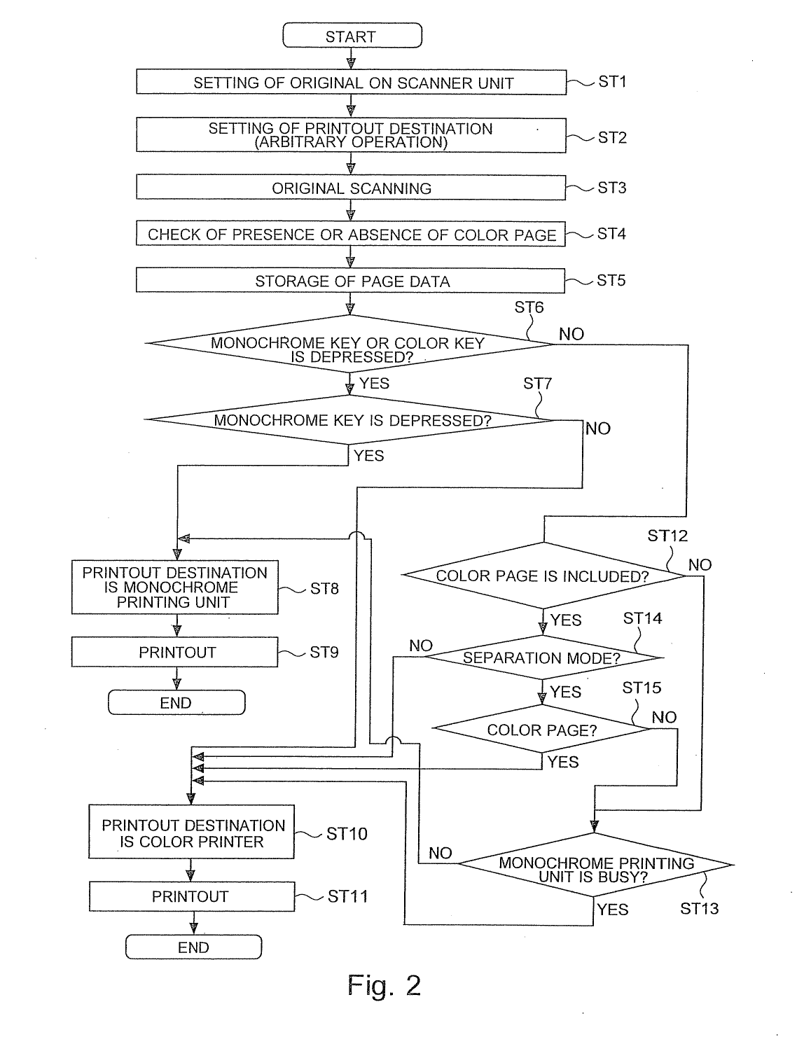

Specific processing that uses the image forming system 100 will be explained. A flowchart in creating a copy of an original is shown in FIG. 2.

The user sets an original on the scanner unit 22 (ST1). The user sets a printout destination of a copy original as required (ST2). The auto key 16a is selected in the default setting. Therefore, the printout destination is automatically designated and set in the separation mode. In ST2, the user may depress the monochrome key 16b or the color key 16c. Further, in ST2, in a state in which the auto key 16a is selected, the user may change the separation mode to the collective mode.

When the user depresses the start key 16s, scanning of the original in the scanner unit 22 is started (ST3). An image scanned is converted into page data. It is checked by the color determining unit 36 whether color page data is included in one or plural pieces of page data (ST4). Thereafter, the page data is compressed and stored in the image-data storing unit 34 (ST5).

Subsequently, a processing route forks depending on the operation in ST2 and a determination result in ST4. First, it is determined whether the monochrome key 16b or the color key 16c is depressed in ST2 (ST6).

When the determination in ST6 is “YES”, it is further determined which key of the monochrome key 16b and the color key 16c is depressed (ST7).

In ST7, it is determined whether “the monochrome key is depressed”. When the determination in ST7 is “YES”, a printout destination is set in the monochrome printing unit 28 (ST8). In this way, regardless of whether the original is a monochrome original, a mixed original, or a color original, the page data stored in the image-data storing unit 34 is sent to the monochrome printing unit 28, printing is performed in the monochrome printing unit 28 (ST9), and the copy job is finished.

When the original is a mixed original or a color original, depending on performance of the monochrome printing unit 28, usually, gray scale printing is performed. In the processing from ST7 to ST9, it is not taken into account whether the monochrome printing unit 28 is busy.

When the determination in ST7 is “NO”, a printout destination is set in the color printer 120 (ST10). Therefore, regardless of whether the original is a monochrome original, a mixed original, or a color original, the page data stored in the image-data storing unit 34 is sent to the color printer 120, printing is performed in the color printer 120 (ST11), and the copy job is finished.

When the determination in ST6 is “NO”, the auto key 16a is depressed. Thus, the output-destination setting unit 40 sets a printout destination on the basis of a result of the check in ST4 (ST12).

In ST12, it is determined “whether a color page is included”. When the determination in ST12 is “NO”, it is further determined whether the monochrome printing unit 28 is busy (ST13).

In ST13, it is determined whether “the printing unit is busy”. When the determination in ST13 is “NO” on the basis of a result of the monitoring by the operation monitoring unit 38, a printout destination is set in the monochrome printing unit 28 (ST8), printing performed in the monochrome printing unit 28 (ST9), and the copy job is finished. On the other hand, when the determination in ST13 is “YES”, a printout destination is set in the color printer 120 (ST10), printing is performed in the color printer 120 (ST11), and the copy job is finished.

When the determination in ST12 is “YES”, subsequently, it is determined which of the separation mode and the collective mode is selected (ST14).

In ST14, it is determined “whether a mode for setting a printout destination is the separation mode”. When the determination in ST14 is “NO”, this means that the collective mode is selected. Therefore, a printout destination is set in the color printer 120 (ST10), printing is performed in the color printer 120 (ST11), and the copy job is finished.

When the determination in ST14 is “YES”, subsequently, it is determined whether the page is a color page or a monochrome page (ST15).

In ST15, it is determined “whether the page is a color page”. When the determination in ST15 is “NO”, in order to check whether it is possible to set a printout destination in the monochrome printing unit 28, it is further determined whether the monochrome printing unit 28 is busy (ST13). When the determination in ST13 is “NO”, a printout destination is set in the monochrome printing unit 28 (ST8), printing is performed in the monochrome printing unit 28 (ST9), and the copy job is finished. On the other hand, when the determination in ST13 is “YES”, a printout destination is set in the color printer 120 (ST10), printing is performed in the color printer 120 (ST11), and the copy job is finished.

On the other hand, when the determination in ST15 is “YES”, a printout destination of the page data is set in the color printer 120 (ST10) and printing is performed in the color printer 120 (ST11). In this case, since printing is performed in two places, namely, the monochrome printing unit 28 and the color printer 120. Thus, the user takes out respective prints and collects the prints into one original.

In the above explanation, the copy job is performed. However, when print data is transmitted from the PC 30, it is possible to perform print processing in the same manner.

When the user desires to designate a printout destination, the user may set the printout destination with the MFP 110 or may designate the printout destination with a printer browser installed in the PC 30. The user may perform the selection of the separation mode and the collective mode with the printer browser.

In performing printing of facsimile data, an administrator and a user of the image forming system 100 do not usually know when the facsimile data is transmitted to the image forming system 100. Therefore, print processing conforming to default conditions is performed.

The embodiment of the invention has been explained. However, the invention is not limited to such an embodiment. It should be understood that various alterations, modifications, and replacements by those skilled in the art are possible within the scope of the invention described in claims and the alterations, the modifications, and the replacements are included in the scope of the invention.

For example, the system in which one color printer is connected to one MFP is explained above. However, a system in which two or more color printers are connected to one MFP may be adopted. In this case, a printer selection key with which the user can select a desired color printer is provided in the key input unit 16. For example, the output-destination setting unit 40 may give the order of priority selection to plural color printers and designate a printout destination in accordance with the order. In this case, when a color printer with a high priority is busy, a color printer of the next candidate is designated as a printout destination. Moreover, the output-destination setting unit 40 may search for a color printer that is not busy and designate the color printer as a printout destination.

In the MFP 110, it is also preferable to provide a so-called interrupt function with which, when the user performs original scanning with the scanner unit 22 during abusy state of the monochrome printing unit 28, a job being executed in the monochrome printing unit 28 is suspended and page data scanned by the scanner unit 22 is preferentially outputted in the monochrome printing unit 28. Similarly, it is also preferable to make it possible to, when the color printer 120 is busy, set a printout destination of page data scanned by the scanner unit 22 in the color printer 120.

Moreover, in the series of processing explained with reference to FIG. 2, when the determination in ST7 is “YES”, a printout destination is set in the monochrome printing unit 28 (ST8) and printing is performed (ST9). In this case, it is not taken into account whether the monochrome printing unit 28 is busy.

It is possible to change this processing flow to a processing flow described below. In short, in ST8, a printout destination is set in the monochrome printing unit 28. Subsequently, it is determined whether the monochrome printing unit 28 is busy. When it is determined that the monochrome printing unit 28 is not busy, printing is promptly performed in the monochrome printing unit 28. On the other hand, when it is determined that the monochrome printing unit 28 is busy, the output-destination setting unit 40 requests an approval of the user on change of the printout destination to the color printer 120 in a message on the liquid crystal display panel 18. When the user approves this request, printout is performed in the color printer 120 and, when the user rejects this request, printout is performed in the monochrome printing unit 28.

In the series of processing explained with reference to FIG. 2, when the determination in ST12 is “YES”, a printout destination is set in the color printer 120 (ST10) and printing is performed in the color printer 120 (ST11). However, it is conceivable that the color printer 120 is also busy. In order to cope with such a situation, it is also possible to provide, in the MFP 110, a color-printer monitoring unit that monitors an operation state of the color printer 120 and give the output-destination selecting unit 42 a function of comparing a result of monitoring by the operation monitoring unit 38 and a result of monitoring by the color-printer monitoring unit and setting a printout destination in the operation monitoring unit 38 or the color-printer monitoring unit in which a job being executed is finished earlier.

What is claimed is:

1. An image forming system comprising:
an image forming apparatus that performs monochrome printing; and
a color printer that performs color printing, the color printer being connected to the image forming apparatus, wherein
the image forming apparatus includes:
a color scanner unit configured to scan an original;
a color determining unit configured to determine whether a color original is included in originals scanned by the color scanner unit;
an image-data storing unit configured to store page data scanned by the color scanner unit;
a monochrome printing unit configured to convert the page data stored in the image-data storing unit into an image and print the image with a monochrome image quality; and
an output-destination setting unit configured to set, when the color determining unit determines that a color original is included in the originals, a printout destination of page data of the color original in the color printer and set a printout destination of page data of the originals other than the color original in the monochrome printing unit.

2. An image forming system according to claim 1, wherein
the image forming apparatus further includes an operation monitoring unit configured to determine whether the monochrome printing unit is busy, and
the output-destination setting unit sets, when the operation monitoring unit determines that the monochrome printing unit is busy, a printout destination of the page data, which is stored in the image-data storing unit, in the color printer.

3. An image forming system according to claim 1, wherein
the image forming apparatus further includes an output-destination selecting unit for a user to designate one of the monochrome printing unit and the color printer as a printout destination, and
the printout destination designated by the user through the output-destination selecting unit is given priority over a printout destination set by the output-destination setting unit on the basis of the determination of the color determining unit.

4. An image forming system according to claim 2, wherein
the image forming apparatus further includes an output selecting unit with which a user can designate one of the monochrome printing unit and the color printer as a printout destination, and
the printout destination designated by the user through the output-destination selecting unit is given priority over a printout destination set by the output-destination setting unit on the basis of the determinations of the color determining unit and the operation monitoring unit.

5. An image forming system according to claim 1, comprising a plurality of the color printers, wherein
the output-destination setting unit sets an order of priority selection in these color printers and designates a color printer to be set as a printout destination in accordance with the setting.

6. An image forming system according to claim 1, comprising a plurality of the color printers, wherein
the output-destination setting unit searches for a color printer that is not busy out of these color printers and designates a color printer to be set as a printout destination.

7. An image forming system according to claim 3, comprising a plurality of the color printers, wherein
the user can designate desired one color printer out of these color printers as a printout destination through the output-destination selecting unit.

8. An image forming system according to claim 1, wherein
the image forming apparatus further includes a LAN interface for transmitting and receiving data to and from a terminal connected via a LAN,
the color determining unit determines whether a color image is included in print data transmitted from the terminal, and
the output-destination setting unit sets, when it is determined that a color image is included in the print data, a printout destination of page data for the color image in the color printer and sets a printout destination of page data other than the page data for the color image in the monochrome printing unit.

9. An image forming system according to claim 1, wherein
the image forming apparatus further includes a facsimile interface for performing transmission and reception of facsimile data through a telephone line,
the color determining unit determines whether a color image is included in facsimile data transmitted through the telephone line, and
the output-destination setting unit sets, when it is determined that a color image is included in the facsimile data, a printout destination of page data for the color image in the color printer and sets a printout destination of page data other than the page data for the color image in the monochrome printing unit.

10. An image forming system comprising:
an image forming apparatus that performs monochrome printing; and
a color printer that performs color printing, the color printer being connected to the image forming apparatus, wherein
the image forming apparatus further includes:
a color scanner unit configured to scan an original;
an image-data storing unit configured to store image data scanned by the color scanner unit;
a monochrome printing unit configured to print the image data stored in the image-data storing unit with a monochrome image quality; and
an operation monitoring unit configured to determine whether the monochrome printing unit is busy, and includes:
an output-destination setting unit configured to set, when the operation monitoring unit determines that the monochrome printing unit is busy, a printout destination of page data in the color printer.

11. An image forming system according to claim 10, wherein
the image forming apparatus further includes an output-destination selecting unit for a user to designate one of the monochrome printing unit and the color printer as a printout destination, and
the printout destination designated by the user through the output-destination selecting unit is given priority over a printout destination set by the output-destination setting unit on the basis of the determination of the operation monitoring unit.

12. An image forming system comprising:
an image forming apparatus that performs monochrome printing; and
a color printer that performs color printing, the color printer being connected to the image forming apparatus, wherein
the image forming apparatus includes:
original scanning means for scanning an original;
color determining means for determining whether a color original is included in originals scanned by the original scanning means;
image-data storing means for storing page data scanned by the original scanning means;
monochrome printing means for converting the page data stored in the image-data storing means into an image and printing the image with a monochrome image quality;
operation monitoring means for determining whether the monochrome printing means is busy; and
an output-destination setting unit configured to set, when the color determining means determines that a color original is included in the originals, a printout destination of page data of the color original in the color printer and set a printout destination of page data of the originals other than the color original in the monochrome printing means and, in that case, when the operation monitoring unit determines that the monochrome printing unit is busy, change the printout destination of the page data from the monochrome printing means to the color printing means.

13. An image forming system according to claim 12, wherein
the image forming apparatus further includes output-destination selecting means for a user to designate one of the monochrome printing means and the color printer as a printout destination, and
the printout destination designated by the user through the output-destination selecting means is given priority over a printout destination set by the output-destination setting means on the basis of the determinations of the color determining means and the driving monitoring means.

14. An image forming system according to claim 12, comprising a plurality of the color printers, wherein
the output-destination setting means sets an order of priority selection in these color printers and designates a color printer to be set as a printout destination in accordance with the setting.

15. An image forming system according to claim 12, comprising a plurality of the color printers, wherein
the output-destination setting means searches for a color printer that is not busy out of these color printers and designates a color printer to be set as a printout destination.

16. An image forming system according to claim 13, comprising a plurality of the color printers, wherein
the user can designates desired one color printer out of these color printers as a printout destination through the output-destination selecting means.
